(19) United States
(12) Patent Application Publication
(10) Pub. No.: US 2023/0306318 A1
(43) Pub. Date: Sep. 28, 2023

(54) SYSTEM AND METHOD FOR OUTAGE FORECASTING

(71) Applicant: ADOBE INC., SAN JOSE, CA (US)

(72) Inventors: Shaddy Garg, Baghapurana (IN); Shubham Agarwal, West Bengal (IN); Sumit Bisht, Rudrapur (IN); Chahat Jain, Delhi (IN); Ashritha Gonuguntla, Chennai (IN); Nikhil Sheoran, Chandigarh (IN); Shiv Kumar Saini, Bangalore (IN)

(21) Appl. No.: 17/656,263

(22) Filed: Mar. 24, 2022

(51) Int. Cl. G06Q 10/04; G06N 7/00; G06N 20/00

(52) U.S. Cl. CPC G06Q 10/04; G06N 7/005; G06N 20/00

(57) ABSTRACT

A method and system for outage forecasting are described. One or more aspects of the method and system include receiving, by a machine learning model, time series data for a service metric of a computer network; generating, by the machine learning model, probability distribution information for the service metric based on the time series data, wherein the probability distribution information is generated using a machine learning model that is trained using a distribution loss and a classification loss; and generating, by a forecasting component, outage forecasting information for the computer network based on the probability distribution information.

### BACKGROUND

The following relates generally to computer networking, and more specifically to outage forecasting.

A computer network is a set of computers sharing resources located on or provided by network nodes such as personal computers, servers, networking hardware, or other specialized or general-purpose hosts. Network computers use common communication protocols over digital interconnections to communicate with each other. Some nodes of a computer network may be used to provide services and computing resources to other nodes in the network. The provider nodes or communication lines between the provider nodes and the receiver nodes may occasionally fail due to various causes, and the provided services and computing resources experience outages in which the service or resource either underperforms or is completely unavailable.

However, conventional outage forecasting systems are not able to accurately predict these outages. Therefore, there is a need in the art for improved outage forecasting models.

### SUMMARY

A method, apparatus, non-transitory computer readable medium, and system for outage forecasting are described. One or more aspects of the method, apparatus, non-transitory computer readable medium, and system include receiving, by a machine learning model, time series data for a service metric of a computer network; generating, by the machine learning model, probability distribution information for the service metric based on the time series data, wherein the machine learning model is trained using a distribution loss based on a distribution output of the machine learning model and a classification loss based on a classification output of the machine learning model; and generating, by a forecasting component, outage forecasting information for the computer network based on the probability distribution information.

A method, apparatus, non-transitory computer readable medium, and system for outage forecasting are described. One or more aspects of the method, apparatus, non-transitory computer readable medium, and system include receiving, by a training component, training data including time series data for a service metric of a computer network and outage data for the computer network; generating probability distribution information for the service metric based on the time series data using a machine learning model; generating threshold outage information based on the time series data using the machine learning model; and updating, by the training component, parameters of the machine learning model based on the probability distribution information, the threshold outage information, and the outage data.

An apparatus and system for outage forecasting are described. One or more aspects of the apparatus and system include a machine learning model configured to generate probability distribution information for a service metric of a computer network based on time series data, wherein the machine learning model is trained using a distribution loss and a classification loss and a forecasting component configured to generate outage forecasting information for the computer network based on the probability distribution information.

### BRIEF DESCRIPTION OF THE DRAWINGS

FIG. 1 shows an example of outage forecasting according to aspects of the present disclosure.

FIG. 2 shows an example of generating outage forecasting information according to aspects of the present disclosure.

FIG. 3 shows an example of obtaining probability distribution information according to aspects of the present disclosure.

FIG. 4 shows an example of change attribution according to aspects of the present disclosure.

FIG. 5 shows an example of obtaining outage forecasting information according to aspects of the present disclosure.

FIG. 6 shows an example of an outage forecasting system according to aspects of the present disclosure.

FIG. 7 shows an example of a machine learning apparatus according to aspects of the present disclosure.

FIG. 8 shows an example of a machine learning model according to aspects of the present disclosure.

FIG. 9 shows an example of a mixture density network according to aspects of the present disclosure.

FIG. 10 shows an example of training a machine learning model according to aspects of the present disclosure.

### DETAILED DESCRIPTION

The present disclosure provides systems and methods for computer network outage forecasting. In at least one embodiment of the present disclosure, a machine learning model receives time series data for a service metric of a computer network and generates probability distribution information for the service metric based on the time series data, where the machine learning model is trained using a distribution loss and a classification loss. A forecasting component generates outage forecasting information for the computer network based on the probability distribution information.

A computer network is a set of computers sharing resources located on or provided by network nodes such as personal computers, servers, networking hardware, or other specialized or general-purpose hosts. The computers use common communication protocols over digital interconnections to communicate with each other. Some nodes of a computer networks are used to provide services and computing resources to other nodes in the network. The provider nodes or communication lines between the provider nodes and the receiver nodes occasionally suffer failures due to various causes, and therefore the provided services and computing resources experience outages in which the service or resource either underperforms or is completely unavailable.

Conventional outage forecasting systems are not able to accurately predict these outages. For example, the outages are not well-defined in terms of metrics that numerically characterize the outage. Some conventional outage forecasting systems attempt to use machine learning to predict outages. However, conventional machine learning models rely on the availability of pre-labeled training data sets, and adequately-sized pre-labeled training data sets are often unavailable. In some cases, outage forecasting systems that use machine learning to predict outages are trained according to loss functions that are relatively simple and inaccurate, or are only useful for outage thresholds encountered during training, and require re-training whenever an outage-likelihood threshold that indicates whether an event is an outage is changed.

Therefore, at least one embodiment of the present disclosure trains a machine learning model based on a distribution loss and a classification loss that accurately account for thresholds that characterize extreme events and do not rely on the availability of a pre-labeled training data set. The distribution loss compares one output of the machine learning model (e.g., a predicted distribution of one or more performance metrics) against observed data, whereas the classification loss compares another output (e.g., a classification of an event as an outage) against ground truth event data. In some embodiments, the distribution output and the classification output are generated by separate output heads (i.e., decoders) that utilize a same encoder portion. Thus, both loss functions can contribute to the accuracy of the model.

By using the trained machine learning model to generate probability distribution data for a service metric based on received time series data for the service metric, the at least one embodiment generates outage forecasting information using a forecasting component that accurately predicts outages, and the outage forecasting information can be used to accurately and reliably alert users of services in a computing network of predicted outages in the services.

Furthermore, the distribution loss and the classification loss teach the machine learning apparatus to generate outage forecasting information that predicts if and when the service metric crosses an arbitrary, changeable threshold set by a user, the machine learning apparatus, or another device in the computer network, thereby avoiding the time and expense of re-training the machine learning model when the threshold is adjusted. Additionally, the outage forecasting information is based on a probability distribution rather than a binary output, affording further flexibility in choosing the threshold. Still further, the distribution loss and the classification loss allow the machine learning model to more accurately predict rare and extreme outages in the computer network than conventional outage forecasting systems.

At least one embodiment of the present disclosure is used in a computer networking context. For example, a computer network such as a cloud or a microservices network may be used to provide user devices with services such as cloud-linked applications, data storage, remote computing power, etc. A machine learning apparatus receives real-time operating information from the computer network and filters the information to identify the most salient information for determining the likelihood that services provided by the computer network will suffer an outage. The machine learning apparatus generates a probability distribution information based on the service metrics using a machine learning model that is trained based on a distribution loss and a classification loss. In at least one embodiment, the distribution loss is based on the probability distribution information, and the classification loss is based on threshold outage information that characterizes extreme or rare outage events in the computer network.

In some embodiments, a forecasting component of the machine learning apparatus generates outage forecasting information for the computer network based on the probability distribution information. In at least one embodiment, the outage forecasting information includes predictions that a service of the computer network will suffer an outage in a predetermined time window based on a predetermined threshold (for example, the threshold may be set to P % likelihood of outage in the next T minutes), and the outage forecasting information will include information indicating any outages that are predicted to occur by the probability distribution information with a greater than P likelihood in the next T minutes.

In at least one embodiment, the machine learning apparatus provides the outage forecasting information to a user device and messages the user with alerts relating to any predicted outages in services that the user participates in through the computer network. In at least one embodiment, the machine learning apparatus uses service deployment data received from the computer network and the probability distribution information to filter a set of changes to services in the computer network that are most likely to have caused any predicted outages. The machine learning apparatus may provide the user with the set of changes.

The term “service” refers to any software or hardware based resource that is shared among users of a computer network. Performance parameters of a service can be referred to as “service metrics.” For example, the service may be a cloud-based application that is displayed via a user device, a data storage or processing power solution provided to the user device, or other such service that is suitable for implementation across a distributed computer network. Service metrics for the application might include processing power usage, memory usage, up-time, and other performance metrics.

The term “time series data” refers to data (e.g., service metric data) that includes a temporal parameter for each value.

The term “outage” refers to any event in a computer network that adversely affects a user experience with a service provided by the computer network. For example, the outage may be a period of high latency, unresponsiveness, unavailability, or other such disruption.

The term “probability distribution information” refers to data that includes a probability value for each of multiple parameter values (e.g., service metric values). In some cases, probability distribution information includes a continuous function over some domain, and in other cases, the probability distribution information includes discrete probability values for discrete outcomes.

The term “distribution loss” refers to a loss function that is based on probability distribution information output by a machine learning model (e.g., a distribution head). During training, a gradient descent process can be used to back propagate changes to parameters of the machine learning model based on the distribution loss.

The term “classification loss” refers to a loss function that is based on classification information output by a machine learning model (e.g., a classification head). During training, a gradient descent process can be used to back propagate changes to parameters of the machine learning model based on the classification loss.

The term “outage forecasting information” refers to information that indicates a likelihood of an outage in a computer network. In some cases, the outage forecasting information can include a confidence value that indicates the confidence of an outage, or probability information that indicates the likelihood that an outage is occurring or will occur.

The term “rare” refers to an outage that happens infrequently relative to other outages. The term “extreme” refers to an outage that occurs with a greater characteristic or large values (such as high intensity or long duration) relative to other outages.

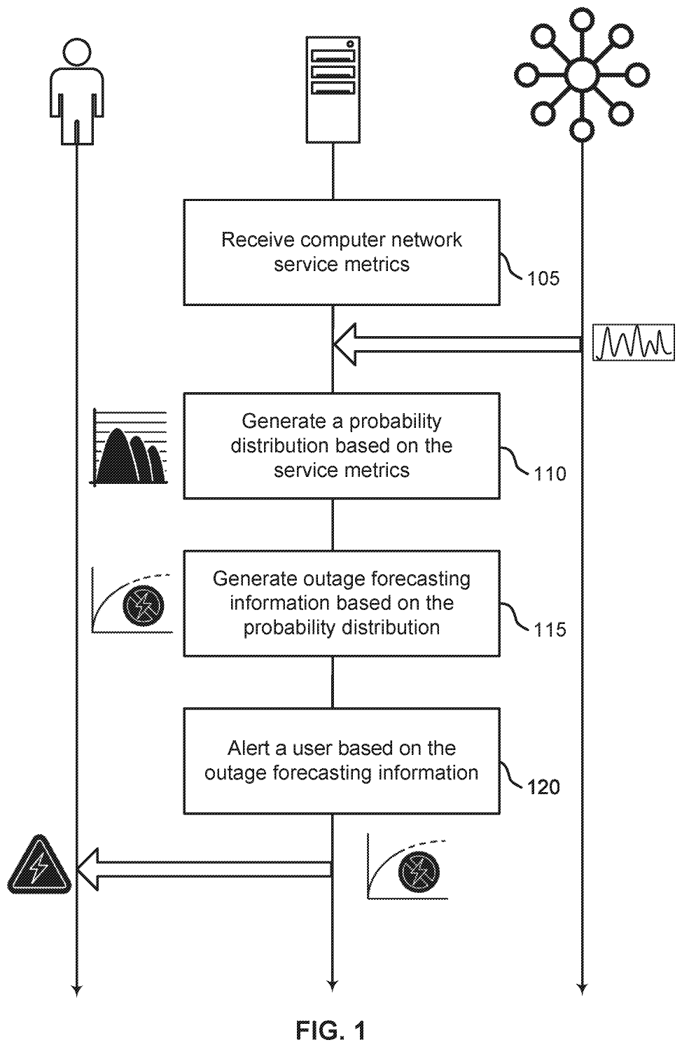

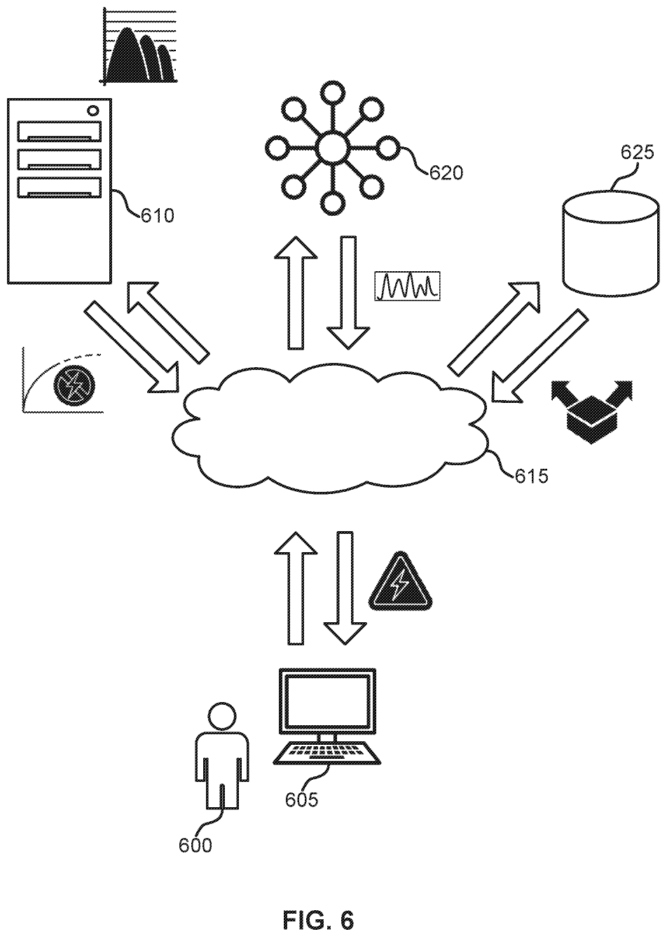

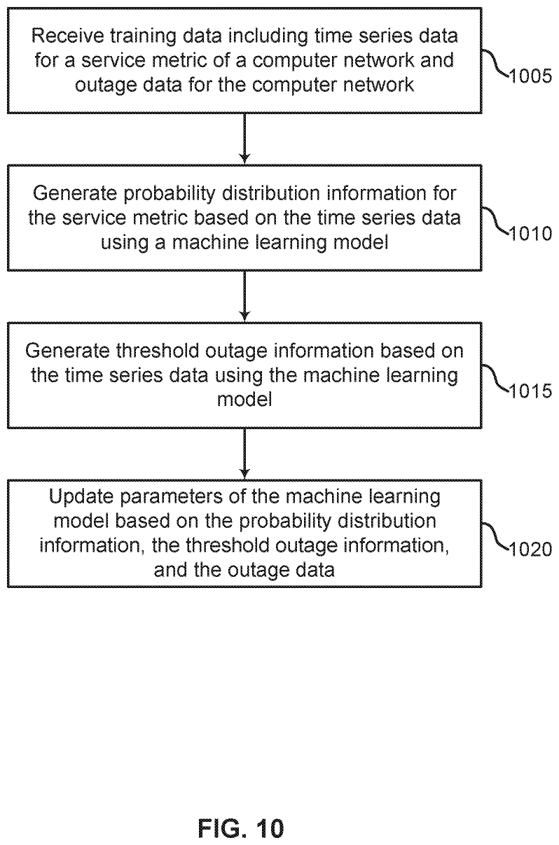

An example application of the present disclosure in the computer networking context is provided with reference to FIGS. 1-6. Details regarding the architecture of an example outage forecasting apparatus are provided with reference to FIGS. 6-9. Examples of a process for training a machine learning model are provided with reference to FIG. 10.

### Outage Forecasting

A method for outage forecasting is described. One or more aspects of the method include receiving time series data for a service metric of a computer network; generating probability distribution information for the service metric based on the time series data, wherein the probability distribution information is generated using a machine learning model that is trained using a distribution loss and a classification loss; and generating outage forecasting information for the computer network based on the probability distribution information.

Some examples of the method further include identifying a plurality of service metrics. Some examples further include computing correlation information for the plurality of service metrics. Some examples further include filtering the plurality of service metrics based on the correlation information to obtain the service metric.

Some examples of the method further include identifying a plurality of service metrics. Some examples further include identifying one or more benchmark indicators. Some examples further include selecting the service metric from the plurality of service metrics based on the one or more benchmark indicators.

Some examples of the method further include collecting data for the service metric for a plurality of instances. Some examples further include computing an aggregate value for the service metric over the plurality of instances at each of a plurality of time steps, wherein the time series data is based on the aggregate value.

Some examples of the method further include encoding the time series data using a recurrent neural network to obtain encoded data. Some examples further include decoding the encoded data using a mixture density network to obtain mixture parameters for a plurality of distributions, wherein the probability distribution information is based on the mixture parameters.

Some examples of the method further include generating a mixing coefficient using the mixture density network, wherein the probability distribution information is based on the mixing coefficient. Some examples of the method further include decoding the encoded data using a classification network to obtain threshold outage information, wherein the outage forecasting information is based on the threshold outage information.

Some examples of the method further include generating a causal graph based on the time series data for the service metric and deployment data related to the service metric. Some examples further include aggregating causality information for a service based on the causal graph, wherein the outage forecasting information is based on the aggregated causality information.

Some examples of the method further include filtering a set of service changes corresponding to the deployment data based on the aggregated causality information. Some examples of the method further include determining that a likelihood of an outage in the computer network exceeds a threshold based on the probability distribution information. Some examples further include transmitting an alert based on the determination.

FIG. 1 shows an example of outage forecasting according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

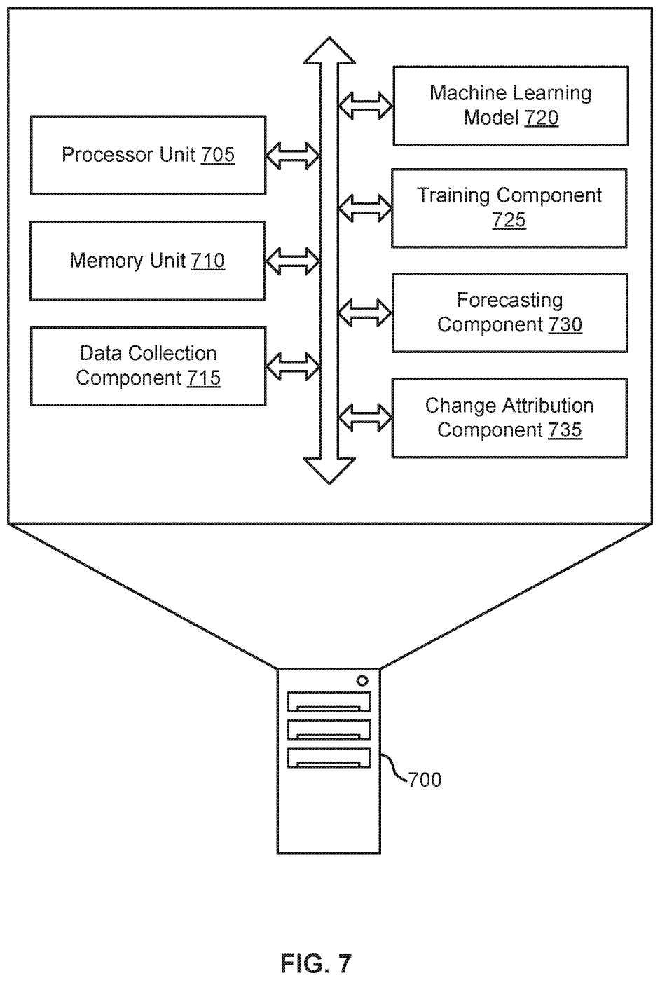

Referring to FIG. 1, a user utilizes a service (such as cloud-based software) provided by a computer network. The service may be associated with the user according to an association list or table that may be stored in a database as described with reference to FIG. 6. In at least one embodiment, a machine learning apparatus as described with reference to FIGS. 6 and 7 predicts outage forecasting information based on a probability distribution and alerts the user to a predicted outage in the service based on the outage forecasting information. In at least one embodiment, the machine learning apparatus identifies that the user should be alerted by cross-referencing a predicted outage of the service and users of the service according to the association list or table.

At operation 105, the system receives computer network service metrics. In some cases, the operations of this step refer to, or may be performed by, a machine learning apparatus as described with reference to FIGS. 6 and 7. In one example, a data collection component of the machine learning apparatus uses a real-time monitoring process to identify service metrics from the computer network that correspond to a health of the service in question. The data collection component may filter the service metrics based on correlation information or benchmark indicators to identify a service metric, and may compute an aggregate value for the service metric over time to identify time series data for the service metric.

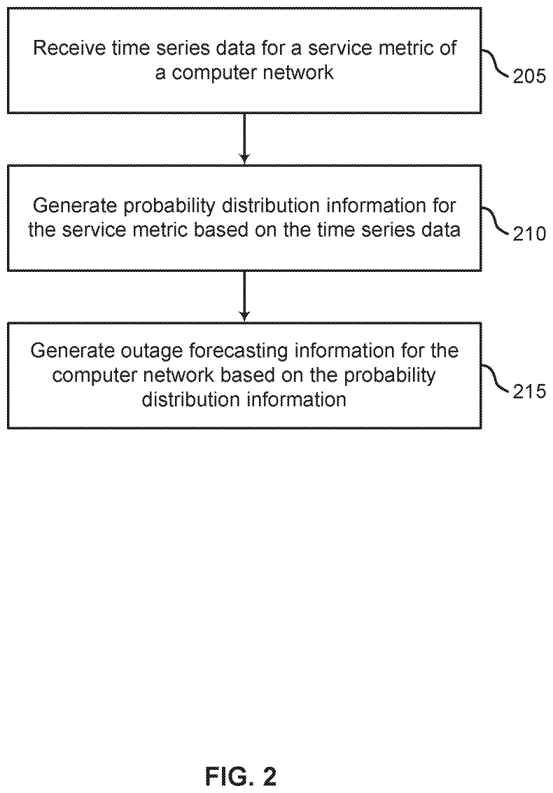

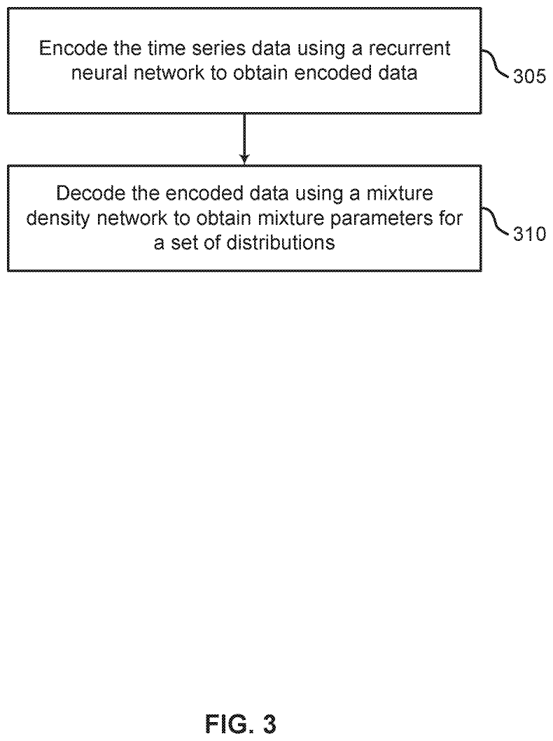

At operation 110, the system generates a probability distribution based on the service metrics. In some cases, the operations of this step refer to, or may be performed by, a machine learning apparatus as described with reference to FIGS. 6 and 7. For example, a machine learning model of the machine learning apparatus may generate a probability distribution based on the time series data corresponding to the service metrics as described with reference to FIGS. 2 and 3.

At operation 115, the system generates outage forecasting information based on the probability distribution. In some cases, the operations of this step refer to, or may be performed by, a machine learning apparatus as described with reference to FIGS. 6 and 7. For example, a forecasting component of the machine learning apparatus may generate outage forecasting information based on the probability distribution as described with reference to FIG. 2.

At operation 120, the system alerts a user based on the outage forecasting information. In some cases, the operations of this step refer to, or may be performed by, a machine learning apparatus as described with reference to FIGS. 6 and 7. For example, the forecasting component of the machine learning apparatus may transmit an alert to a user device via a cloud as described with reference to FIG. 6 that identifies the service that the user is associated with, as well as the predicted extent and duration of an outage of the service. The alert may be transmitted via email, SMS message, in-app notification and message, or other suitable methods of communicating information via electronic devices.

FIG. 2 shows an example of generating outage forecasting information according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 2, a machine learning apparatus as described with reference to FIGS. 6 and 7 may generate probability distribution information for a service metric of a computer network based on times series data for the service metric, and may generate outage forecasting information for the computer network based on the probability distribution information. In an example, live service metrics from the computer network are fed into a data collection component of the machine learning apparatus. Next, a machine learning model that is trained to learn the distribution of a metric may predict a probability distribution for the service metric. The probability distribution may be used by the machine learning apparatus for generating outage forecasting information that predicts if and when the metric may cross an arbitrary threshold set by a user, the machine learning apparatus, or another device in the computer network.

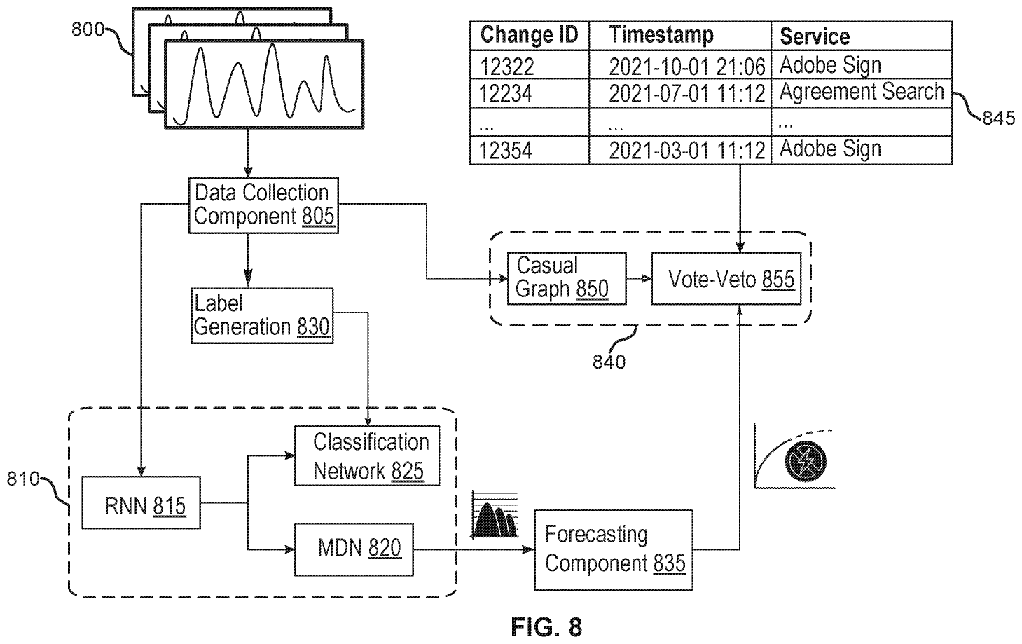

At operation 205, the system receives time series data for a service metric of a computer network. In some cases, the operations of this step refer to, or may be performed by, a machine learning model as described with reference to FIGS. 7 and 8. In at least one embodiment, the machine learning model receives the time series data from a data collection component of the machine learning apparatus.

For example, in at least one embodiment, a data collection component of the machine learning apparatus identifies a plurality of service metrics by fetching data using various performance monitoring tools, such as NewRelic, Grafana, etc. The service metrics may capture the “health” of a service in terms of performance relative to expected performance, downtime, etc. The service metrics correlate to an outage in the service.

In at least one embodiment, the data collection component computes correlation information for the plurality of service metrics [symbol] ₐₗₗ and filters the plurality of service metrics [symbol] ₐₗₗ based on the correlation information to obtain the service metric [symbol] ∈ [symbol] ₐₗₗ. For example, the plurality of service metrics [symbol] ₐₗₗ may include service metrics for which Service Reliability Engineers (SRE) or Quality of Service (QoS) literature has quantified outages. These metrics may be continuously monitored by the data collection component to track the health of the service in question. The plurality of service metrics [symbol] ₐₗₗ may also include metrics identified by Rate Error Duration (RED) and Utilization Saturation Error (USE) processes of the data collection component. The RED and USE processes provide comprehensive and consistent views of the computer network. The service metric [symbol] is obtained by filtering out highly correlated metrics from the plurality of service metrics to remove derived metrics.

In at least one embodiment, the data collection component identifies one or more benchmark indicators and selects the service metric [symbol] from the plurality of service metrics [symbol] ₐₗₗ based on the one or more benchmark indicators. For example, the data collection component may use outage alert definitions provided by an SRE team as well as Service Level Objective (SLO) definitions that serve as benchmarks for indicators, parameters, or metrics associated with service-level targets (e.g., thresholds). These benchmarks may be used to quantify user happiness with a service. The service metric [symbol] may be chosen from the plurality of service metrics identified based on these benchmark indicators.

In at least one embodiment, the data collection component collects data for the service metric for a plurality of instances and computes an aggregate value for the service metric over the plurality of instances at each of a plurality of time steps, wherein the time series data is based on the aggregate value. For example, each service in the computer network may run multiple instances at any given time. The data collection component collects data for the service metric at an instance level. However, a variable number of instances over time may make it difficult to model the service metric at an instance level. For example, a CPU utilization metric for a service may have a same number of values as the number of instances of the CPU utilization metric. Therefore, the data collection component may reduce the complexity of the data by computing an aggregate value across all instances for the service metric at each time step. The aggregate value may be an average value, a maximum value, or a minimum value of the service metric across the instances. The aggregate value allows the data collection component to find a probability of at least one instance of the service metric that faces an outage. The data collection component then may base the time series data on the aggregate value.

In at least one embodiment, the data collection component pre-processes the service metric by removing missing values in data fields corresponding to the service metric. For example, the data collection component may replace missing values with zeroes, and/or may remove rows relating to the missing values. For example, if the service metric includes missing values for a server error metric, but the service does not relate to a server, the data collection component may replace the missing values with zeroes, as the zeroes denote that there is no server error that corresponds to the service. As another example, the data collection component may receive a service metric that includes missing values for CPU utilization of the service, and those missing values may be dropped if they are due to a fault of the monitoring system rather than a fault with the service corresponding to the service metric.

At operation 210, the system generates probability distribution information for the service metric based on the time series data. In some cases, the operations of this step refer to, or may be performed by, a machine learning model as described with reference to FIGS. 7 and 8. For example, the machine learning model may generate probability distribution information for the service metric based on the time series data as described with reference to FIG. 3. In at least one embodiment, the machine learning model is trained using a distribution loss and a classification loss. For example, the machine learning model may be trained by a training component to learn the probability distribution information for outages in computer networks as described with reference to FIG. 10.

At operation 215, the system generates outage forecasting information for the computer network based on the probability distribution information. In some cases, the operations of this step refer to, or may be performed by, a forecasting component as described with reference to FIGS. 7 and 8. For example, the forecasting component may use the probability distribution information to determine the likelihood that the service metric will exceed a predetermined threshold in a predetermined timeframe, and may generate forecasting information that includes at least one of the service, the threshold, the likelihood or probability of the service suffering an outage due to exceeding the threshold, and the timeframe for when the outage will occur and the duration of the outage. The threshold may be determined by a user of the computer network, a user of the machine learning apparatus, and/or the machine learning apparatus itself, and the threshold may be communicated to the forecasting component via a user device or server that is connected to the computer network and machine learning apparatus. For example, the threshold may be a percentage likelihood that the service corresponding to the service metric will suffer an outage over a set time period.

Conventional outage forecasting systems only work via thresholds that are set prior to training a machine learning model, and the conventional machine learning models therefore need to be updated whenever a different threshold is chosen. However, at least one embodiment of the present disclosure generates outage forecasting information based on a probability distribution information, and not binary values, and therefore, any arbitrary threshold may be chosen. The machine learning model of a machine learning apparatus according to at least one embodiment does not need to be updated whenever a new outage threshold is desired.

In at least one embodiment, the forecasting component may transmit an alert based on the determination that the likelihood of an outage in the computer network exceeds a threshold. For example, the forecasting component may communicate with a user device via a cloud as described with reference to FIG. 6 to display a real-time view of the outage forecasting information being tracked. In at least one embodiment, the forecasting component displays the forecasting information via the user device in real time. The forecasting component may send an alert to the user device (via email, SMS messaging, in-app or in-software notification, etc.) when the threshold is exceeded and the forecasting component predicts an outage. The alert may include information relating to the outage prediction, and/or may include a message directing the user to review the forecasting information that has been provided to the user device.

FIG. 3 shows an example of obtaining probability distribution information according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 3, a machine learning model as described with reference to FIG. 7 may generate probability distribution information for the service metric based on the time series data.

At operation 305, the system encodes the time series data using a recurrent neural network (RNN) to obtain encoded data. In some cases, the operations of this step refer to, or may be performed by, a recurrent neural network as described with reference to FIG. 8. RNNs are a type of artificial neural network (ANN) that are useful in forecasting time series data. The machine learning model may apply a forward layer of the RNN to the input sequence of the time series data and may apply a backward layer of the RNN to a reverse form of the time series data to output encoded data.

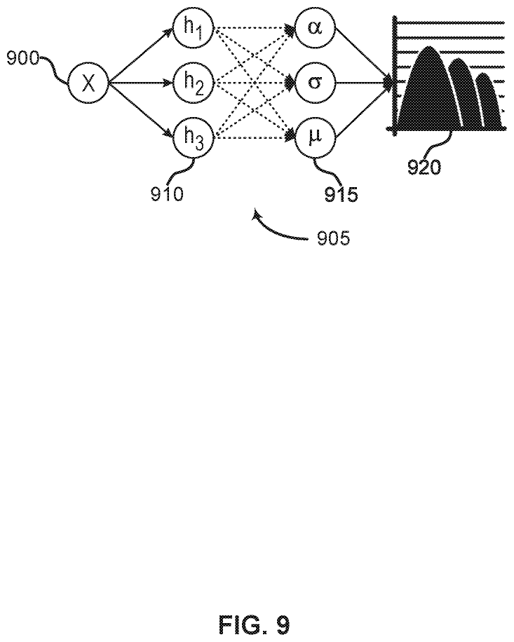

At operation 310, the system decodes the encoded data using a mixture density network to obtain mixture parameters for a set of distributions. In some cases, the operations of this step refer to, or may be performed by, a mixture density network as described with reference to FIGS. 8 and 9.

Given a vector x of service metrics (e.g., the encoded data), the machine learning model predicts the distribution for the service metrics y∈ [symbol] ₐₗₗ. More precisely, the machine learning model estimates the probability of mᵢ given x and probability distribution p(y|x). Generally, the metric mᵢ is assumed to follow a gaussian distribution, and the machine learning model is used to learn the parameters mean μ and standard deviation σ of this gaussian distribution. However, in many cases, the service metric does not follow a gaussian distribution. Therefore, the machine learning model may use a Mixture Density Network (MDN) that combines a deep neural network (DNN) and a mixture of distributions to learn the mixture parameters μ and σ as well as a mixing coefficient α.

Accordingly, the machine learning model decodes the encoded data using the MDN to obtain mixture parameters for a set of distributions, where the probability distribution information is based on the mixture parameters. In at least one embodiment, the machine learning model generates a mixing coefficient using the MDN, wherein the probability distribution information p(y|x) is based on the mixing coefficient. Formally,

$$p ( y \vert x ) = {\sum }_{c = 1}^{C} {α}_{c} ( x ) 𝔻 ( y \vert {λ}_{1 , c} ( x ) , {λ}_{2 , c} ( x ) , … ) \qquad ( 1 )$$

where c denotes the index of a corresponding mixture component, α is the mixing parameter, [symbol] is the distribution to be used, such as a gaussian distribution, and λ denotes the parameters of the distribution [symbol] (e.g., μ(x) and σ(x)). A gaussian mixture model may model any arbitrary probability distribution.

In at least one embodiment, the machine learning model is trained by a training component according to a distribution loss based on the probability distribution information and the outage data as described with reference to FIG. 10.

In at least one embodiment, the machine learning model decodes the encoded data using a classification network to obtain threshold outage information, wherein the outage forecasting information is based on the threshold outage information. For example, the machine learning model may use the classification network to increase the ability of the machine learning model to accurately predict extreme or rare events that may appear in the tails of the probability distribution information. The classification network may be trained as described with reference to FIG. 10 to learn the probability of these rare events in the tails of the probability distribution information, so that the classification network outputs threshold outage information in response to receiving the encoded data and ground truth labels as input. The machine learning model may use a multi-task learning approach to jointly train the mixture density network and the classification network, with the classification network learning the distribution of rare and/or extreme events, such that the outage forecasting information generated based on the probability distribution information provided by the machine learning model is based on the threshold outage information provided by the classification network. The multi-task learning approach is further described with reference to FIG. 10.

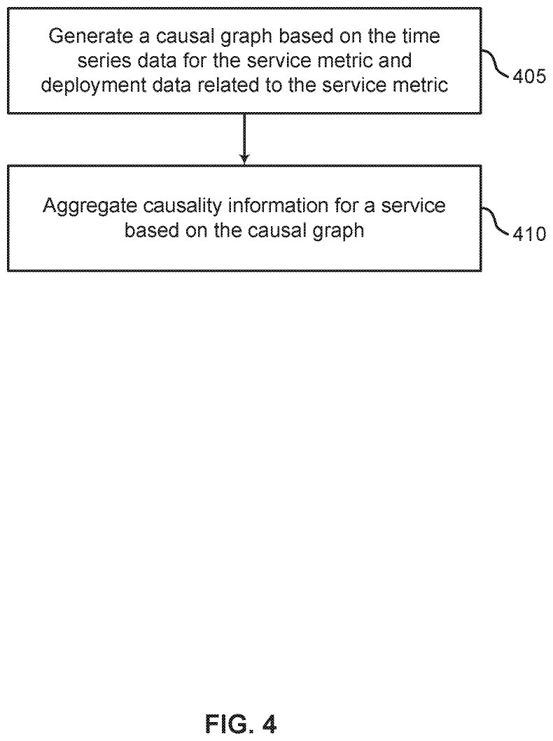

FIG. 4 shows an example of change attribution according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 4, a machine learning apparatus as described with reference to FIGS. 6 and 7 may predict likely causes (change events) that may be responsible for a predicted outage. The machine learning model may use outage and change timestamps obtained from deployment data related to a service metric to as sign a “temporal blame score” to changes made to a service corresponding to the service metric and to other services called by the service.

At operation 405, the system generates a causal graph based on the time series data for the service metric and deployment data related to the service metric. In some cases, the operations of this step refer to, or may be performed by, a change attribution component as described with reference to FIGS. 7 and 8. For example, the change attribution component may use the outage forecasting information, the time series data for the service metric, and deployment data for the service and related services to find the top service changes responsible for each outage predicted in the outage forecasting information. The deployment data may be obtained directly from the computer network, or may be retrieved from a database such as a database as described with reference to FIG. 6.

The change attribution component may receive deployment data relating to services of the computer network. For each outage alert for a service predicted in the outage forecasting information, the change attribution component checks deployment events in other services of the computer network that the service depends upon, as any fault in a function that is critical for the service can propagate to the service. The change attribution component constructs a causal graph based on the time series data for the service metric and the deployment data. In at least one embodiment, domain knowledge used in the construction of the causal graph is based on a call graph provided by a SRE.

At operation 410, the system aggregates causality information for a service based on the causal graph. In some cases, the operations of this step refer to, or may be performed by, a change attribution component as described with reference to FIGS. 7 and 8. For example, the change attribution component may use a vote-veto approach to identify the top-k changes responsible for a given outage alert in the outage forecasting information. In at least one embodiment, the change attribution component identifies four different time windows (for example, 1 hour, 24 hours, 72 hours, and a time period equal to the difference between deployment of the service and the latest data point in the deployment data). The change attribution component then relates predicted outages in the outage forecasting information to changes deployed in the time windows by making a vote-veto computation, where any outage that is predicted to occur after the deployment event votes for the change, while any outage that is predicted to occur before the deployment even vetoes a vote for the change. The change attribution component may aggregate the vote-veto scores as follows:

$${P}_{i} = {\sum }_{k} V ( a , c \vert {WD}_{i} ) \qquad ( 2 )$$

$$B = {\sum }_{k} V O ( a , c \vert {WD}_{- 1} ) \qquad ( 3 )$$

$$Score ( a , c ) = {\sum }_{i ∈ [ 1 , 4 ]} {w}_{i} log ( \frac{{P}_{i} - B + 1}{B + 1} ) \qquad ( 4 )$$

where a represents the outage alert, c represents the change, WD represents the four time windows, Pᵢ represents the vote score for the ith time window, B represents the veto score, k refers to different outage alerts predicted over the time window, and wᵢ refers to the weight of time windows. The time window weights are in exponentially decreasing order from w₁ to w₄.

In at least one embodiment, the change attribution component filters a set of service changes corresponding to the deployment data based on the aggregated causality information. For example, the change attribution component may filter a list of top-k changes with the highest vote-veto scores from the deployment data. In at least one embodiment, the machine learning apparatus provides the set of service changes corresponding to the deployment data to a user. For example, the machine learning apparatus may provide the user with a list of changes in service deployments in the computer network that most likely caused the predicted outages in the outage forecasting information. Hence, to the extent an outage is due to a change event, pinpointing the most probable deployment events may help in accelerating a remediation process.

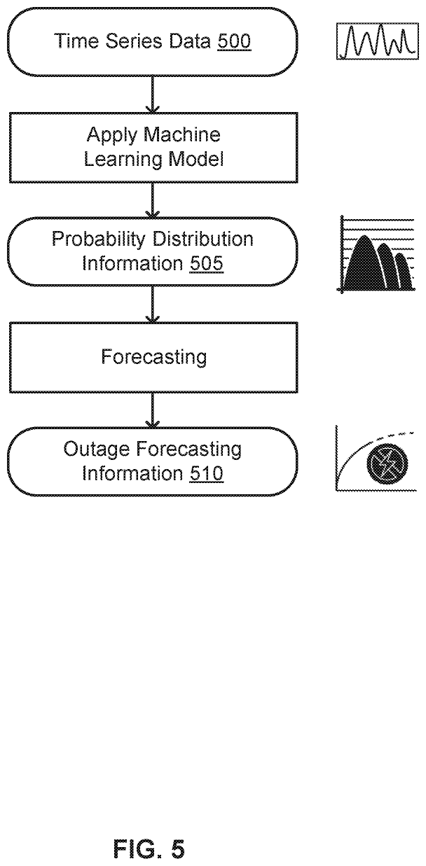

FIG. 5 shows an example of obtaining outage forecasting information 520 according to aspects of the present disclosure. The example shown includes time series data 500, probability distribution information 510, and outage forecasting information 515.

Referring to FIG. 5, a machine learning apparatus as described with reference to FIGS. 6 and 7 applies a machine learning model to time series data 500 for a service metric obtained from a computer network to generate probability distribution information 510. In at least one embodiment, time series data 500 is based on an aggregate value of collected data for the service metric for a plurality of instances. In at least one embodiment, probability distribution information 510 is obtained by decoding encoded data using a mixture density network. The machine learning model provides probability distribution information 510 to a forecasting component of the machine learning apparatus, and the forecasting component generates outage forecasting information 515 based on probability distribution information 510. In at least one embodiment, outage forecasting information 515 includes predictions of outages that may occur for a service corresponding to the service metric based on exceeding a threshold probability.

### System Architecture

An apparatus for outage forecasting is described. One or more aspects of the apparatus include a machine learning model configured to generate probability distribution information for a service metric of a computer network based on time series data, wherein the machine learning model is trained using a distribution loss and a classification loss and a forecasting component configured to generate outage forecasting information for the computer network based on the probability distribution information.

Some examples of the apparatus further include a data collection component configured to collect the time series data for the service metric. Some examples of the apparatus further include a change attribution component configured to filter a set of service changes corresponding to deployment data based on the probability distribution information.

FIG. 6 shows an example of an outage forecasting system according to aspects of the present disclosure. The example shown includes user 600, user device 605, machine learning apparatus 610, cloud 615, computer network 620, and database 625.

Referring to FIG. 6, user 600 may use machine learning apparatus 610 to obtain alerts and outage forecasting information relating to a service provided by computer network 620. The outage forecasting information may include predictions of service outages that are likely to occur over a predetermined time window. Machine learning apparatus 610 may generate the outage forecasting information based on probability distribution information that is generated based on time series data for a service metric received from computer network 620. Machine learning apparatus 610 may display a real-time view of the outage forecasting information on user device 605 and may transmit alerts for likely outages to user device 605.

User device 605 may be a personal computer, laptop computer, mainframe computer, palmtop computer, personal assistant, mobile device, or any other suitable processing apparatus. In some examples, user device 605 includes software that receives and displays outage forecasting information and outage alerts for a selected service or services from machine learning apparatus 610 via cloud 615. In at least one embodiment, the software displays the outage forecasting information as a real-time view that is updated when machine learning apparatus 610 generates new outage forecasting information. In at least one embodiment, user device 605 displays receives and displays the outage alerts as one or more of an email, an SMS message, a pop-up notification, or in-software notification.

A user interface may enable user 600 to interact with user device 605. In some embodiments, the user interface may include an audio device, such as an external speaker system, an external display device such as a display screen, or an input device (e.g., a remote control device interfaced with the user interface directly or through an IO controller module). In some cases, the user interface may be a graphical user interface (GUI).

Machine learning apparatus 610 may include a computer implemented network that includes a machine learning model including one or more neural networks. Machine learning apparatus 610 may also include one or more processors, a memory subsystem, a communication interface, an I/O interface, one or more user interface components, and a bus. Additionally, machine learning apparatus 610 may communicate with user device 605, computer network 620, and database 625 via cloud 615.

In some cases, machine learning apparatus 610 is implemented on a server. A server provides one or more functions to users linked by way of one or more of various networks, such as cloud 615 and computer network 620. In some cases, the server includes a single microprocessor board, which includes a microprocessor responsible for controlling all aspects of the server. In some cases, a server uses microprocessor and protocols to exchange data with other devices or users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general purpose computing device, a personal computer, a laptop computer, a mainframe computer, a supercomputer, or any other suitable processing apparatus.

Further detail regarding the architecture of machine learning apparatus is provided with reference to FIGS. 7-9. Further detail regarding a process for outage forecasting is provided with reference to FIGS. 1-5. Further detail regarding a process for training the machine learning model is provided with reference to FIG. 10. Machine learning apparatus 610 is an example of, or includes aspects of, the corresponding element described with reference to FIG. 7.

A cloud such as cloud 615 is a computer network configured to provide on-demand availability of computer system resources, such as data storage and computing power. In some examples, cloud 615 provides resources without active management by user 600. The term “cloud” is sometimes used to describe data centers available to many users over the Internet. Some large cloud networks have functions distributed over multiple locations from central servers. A server is designated an edge server if it has a direct or close connection to a user. In some cases, cloud 615 is limited to a single organization. In other examples, cloud 615 is available to many organizations. In one example, cloud 615 includes a multi-layer communications network comprising multiple edge routers and core routers. In another example, cloud 615 is based on a local collection of switches in a single physical location. Cloud 615 may provide communications between user device 605, machine learning apparatus 610, computer network 620, and database 625.

In some aspects, computer network 620 is implemented as a cloud network similar to cloud 615. In at least one embodiment, computer network 620 is implemented as cloud 615. Computer network 620 may provide one or more services to users of computer network 620, such as cloud-based software or computing resources such as data storage, computational power, etc.

In at least one embodiment, computer network 620 is a microservices network. A microservice network arranges an application as a collection of loosely-coupled services that are provided to users of the network. In a microservices network, the services are fine-grained and the protocols are lightweight. Services in a microservice network are often processes that communicate over the network to fulfill a goal using protocols such as HTTP. The services may be implemented using various programming languages, databases, and hardware and software environments. The services in a microservices network may be small in size, messaging-enabled, bounded by contexts, autonomously developed, independently deployable, decentralized, and/or built and released with automated processes.

A database such as database 625 is an organized collection of data. For example, database 625 stores data in a specified format known as a schema. Database 625 may be structured as a single database, a distributed database, multiple distributed databases, or an emergency backup database. In some cases, a database controller may manage data storage and processing in database 625. In some cases, user 600 interacts with the database controller. In other cases, the database controller may operate automatically without user interaction. Database may store information provided by computer network 620, such as deployment data and service metrics, and information provided by machine learning apparatus 610, such as probability distribution information and outage forecasting information.

FIG. 7 shows an example of a machine learning apparatus according to aspects of the present disclosure. Machine learning apparatus 700 is an example of, or includes aspects of, the corresponding element described with reference to FIG. 6. In one aspect, machine learning apparatus 700 includes processor unit 705, memory unit 710, data collection component 715, machine learning model 720, training component 725, forecasting component 730, and change attribution component 735.

Processor unit 705 includes one or more processors. A processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, processor unit 705 is configured to operate a memory array using a memory controller. In other cases, a memory controller is integrated into processor unit 705. In some cases, processor unit 705 is configured to execute computer-readable instructions stored in memory unit 710 to perform various functions. In some embodiments, processor unit 705 includes special purpose components for modem processing, baseband processing, digital signal processing, or transmission processing.

Memory unit 710 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor of processor unit 705 to perform various functions described herein. In some cases, memory unit 710 contains, among other things, a basic input/output system (BIOS) which controls basic hardware or software operation such as the interaction with peripheral components or devices. In some cases, memory unit 710 includes a memory controller that operates memory cells of memory unit 710. For example, the memory controller may include a row decoder, column decoder, or both. In some cases, memory cells within memory unit 710 store information in the form of a logical state.

According to some aspects, data collection component 715 identifies a set of service metrics. In some examples, data collection component 715 computes correlation information for the set of service metrics. In some examples, data collection component 715 filters the set of service metrics based on the correlation information to obtain the service metric.

In some examples, data collection component 715 identifies a set of service metrics. In some examples, data collection component 715 identifies one or more benchmark indicators. In some examples, data collection component 715 selects the service metric from the set of service metrics based on the one or more benchmark indicators.

In some examples, data collection component 715 collects data for the service metric for a set of instances. In some examples, data collection component 715 computes an aggregate value for the service metric over the set of instances at each of a set of time steps, where the time series data is based on the aggregate value.

According to some aspects, data collection component 715 is configured to collect the time series data for the service metric. Data collection component 715 is an example of, or includes aspects of, the corresponding element described with reference to FIG. 8. Data collection component 715 may be implemented as a hardware circuit, in firmware, or as a software component.

Machine learning model 720 may include one or more artificial neural networks (ANNs). An ANN is a hardware or a software component that includes a number of connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. In some examples, nodes may determine their output using other mathematical algorithms (e.g., selecting the max from the inputs as the output) or any other suitable algorithm for activating the node. Each node and edge is associated with one or more node weights that determine how the signal is processed and transmitted.

In ANNs, a hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the neural network. Hidden representations are machine-readable data representations of an input that are learned from a neural network's hidden layers and are produced by the output layer. As the neural network's understanding of the input improves as it is trained, the hidden representation is progressively differentiated from earlier iterations.

During a training process of an ANN, the node weights are adjusted to improve the accuracy of the result (i.e., by minimizing a loss which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

According to some aspects, machine learning model 720 receives time series data for a service metric of a computer network. In some examples, According to some aspects, machine learning model 720 generates probability distribution information for the service metric based on the time series data. In some examples, machine learning model 720 generates threshold outage information based on the time series data.

According to some aspects, machine learning model 720 encodes the time series data using a recurrent neural network to obtain encoded data. The recurrent neural network is an example of, or includes aspects of, the corresponding element described with reference to FIG. 8.

According to some aspects, machine learning model 720 decodes the encoded data using a mixture density network to obtain mixture parameters for a set of distributions, where the probability distribution information is based on the mixture parameters. In some examples, machine learning model 720 generates a mixing coefficient using the mixture density network, where the probability distribution information is based on the mixing coefficient. According to some aspects, machine learning model 720 decodes the encoded data using the mixture density network to obtain mixture parameters for a set of distributions, where the probability distribution information is based on the mixture parameters. The mixture density network is an example of, or includes aspects of, the corresponding element described with reference to FIGS. 8 and 9.

According to some aspects, machine learning model 720 decodes the encoded data using a classification network to obtain threshold outage information, where the outage forecasting information is based on the threshold outage information. The classification network is an example of, or includes aspects of, the corresponding element described with reference to FIG. 8.

According to some aspects, machine learning model 720 is trained by a training component using a distribution loss and a classification loss. According to some aspects, machine learning model 720 is configured to generate probability distribution information for a service metric of a computer network based on time series data. Machine learning model 720 is an example of, or includes aspects of, the corresponding element described with reference to FIG. 8.

According to some aspects, training component 725 receives training data including time series data for a service metric of a computer network and outage data for the computer network. In some examples, training component 725 updates parameters of machine learning model 720 based on the probability distribution information, the threshold outage information, and the outage data. In some examples, training component 725 computes a distribution loss based on the probability distribution information and the outage data, where the parameters of machine learning model 720 are updated based on the distribution loss.

In some examples, training component 725 generates outage label data based on the outage data. In some examples, training component 725 computes a binary cross-entropy loss based on the threshold outage information and the outage label data, where the parameters of machine learning model 720 are updated based on the binary cross-entropy loss. In some examples, training component 725 computes an extreme value loss based on the threshold outage information and the outage label data, where the parameters of machine learning model 720 are updated based on the extreme value loss. Training component 725 is an example of, or includes aspects of, the corresponding element described with reference to FIG. 8. In various embodiments, training component 725 may be implemented as a hardware circuit, in firmware, or as a software component.

According to some aspects, forecasting component 730 generates outage forecasting information for the computer network based on the probability distribution information. In some examples, forecasting component 730 determines that a likelihood of an outage in the computer network exceeds a threshold based on the probability distribution information. In some examples, forecasting component 730 transmits an alert based on the determination.

According to some aspects, forecasting component 730 is configured to generate outage forecasting information for the computer network based on the probability distribution information. Forecasting component 730 is an example of, or includes aspects of, the corresponding element described with reference to FIG. 8. In various embodiments, forecasting component 730 may be implemented as a hardware circuit, in firmware, or as a software component.

According to some aspects, change attribution component 735 generates a causal graph based on the time series data for the service metric and deployment data related to the service metric. In some examples, change attribution component 735 aggregates causality information for a service based on the causal graph, where the outage forecasting information is based on the aggregated causality information. In some examples, change attribution component 735 filters a set of service changes corresponding to the deployment data based on the aggregated causality information.

According to some aspects, change attribution component 735 is configured to filter a set of service changes corresponding to deployment data based on the probability distribution information. Change attribution component 735 is an example of, or includes aspects of, the corresponding element described with reference to FIG. 8. In various embodiments, change attribution component 735 may be implemented as a hardware circuit, in firmware, or as a software component.

FIG. 8 shows an example of a machine learning model according to aspects of the present disclosure. The example shown includes plurality of service metrics 800, data collection component 805, machine learning model 810, label generation process 830, forecasting component 835, change attribution component 840, deployment data 845, causal graph 850, and vote-veto scores 855.

Referring to FIG. 8, data collection component 805 of a machine learning apparatus as described with reference to FIGS. 6 and 7 receives plurality of service metrics 800 for a computer network as described with reference to FIG. 6. Data collection component 805 may provide time series data to machine learning model 810 as described with reference to FIGS. 2 and 3. Data collection component 805 is an example of, or includes aspects of, the corresponding element described with reference to FIG. 7.

Machine learning model 810 of the machine learning apparatus generates probability distribution information for the service metric based on the time series data. For example, machine learning model 810 generates the probability distribution information as described with reference to FIGS. 2 and 3. Machine learning model 810 is an example of, or includes aspects of, the corresponding element described with reference to FIG. 7. In one aspect, machine learning model 810 includes recurrent neural network 815, mixture density network 820, and classification network 825.

In one aspect, the machine learning model 810 includes recurrent neural network (RNN) 815. An RNN is a class of ANN in which connections between nodes form a directed graph along an ordered (e.g., temporal) sequence. This enables an RNN to model temporally dynamic behavior such as predicting what element should come next in a sequence. Thus, an RNN is suitable for tasks that involve ordered sequences such as text recognition (where words are ordered in a sentence). The term RNN may include finite impulse recurrent networks (characterized by nodes forming a directed acyclic graph), and infinite impulse recurrent networks (characterized by nodes forming a directed cyclic graph).

In at least one embodiment, RNN 815 comprises a bidirectional LSTM (BiLSTM) model. The BiLSTM model may include two Long Short-Term Memory (LSTM) networks. An LSTM is a form of RNN that includes feedback connections. In one example, and LSTM includes a cell, an input gate, an output gate and a forget gate. The cell stores values for a certain amount of time, and the gates dictate the flow of information into and out of the cell. LSTM networks may be used for making predictions based on series data where there can be gaps of unknown size between related information in the series. LSTMs can help mitigate the vanishing gradient (and exploding gradient) problems when training an RNN.

In one aspect, the machine learning model 810 includes mixture density network (MDN) 820. Mixture density network 820 may combine a deep neural network (DNN) and a mixture of distributions to learn mixture parameters as well as a mixing coefficient. A DNN is a many-layered (“deep”) ANN. DNNs are useful in modeling complex non-linear relationships. The extra layers of a DNN enable composition of features from lower layers, modelling complex data with fewer units than a similarly performing “shallow” network. Examples of DNNs include RNNs and convolutional neural networks (CNNs).

In one aspect, the machine learning model 810 includes classification network 825. A classification network comprises an ANN that is used for classifying data. The classification network 825 may be trained using a labeled dataset (e.g., a labeled dataset provided by a training component of the machine learning apparatus). In some cases, the training data in the dataset is encoded by RNN 815. The training component may generate the labels for unlabeled training data during a label generation process 830. Classification network 825 may be used for learning distributions of threshold outage information, with probabilities that occur in the “tails” of probability distribution information generated by mixture density network 820. Mixture density network 820 and classification network 825 may be trained using a multi-task learning approach such that the probability distribution information generated by mixture density network 820 properly accounts for threshold outage information such as rare or extreme outage events.

In at least one embodiment, at least one of mixture density network 820 and classification network 825 is implemented as a fully connected network. A fully connected neural network includes a series of fully connected layers. A fully connected layer is a function in which each output dimension depends on each input dimension.

According to some aspects, recurrent neural network 815 encodes the time series data to obtain encoded data. According to some aspects, mixture density network 820 decodes the encoded data to obtain mixture parameters for a set of distributions, where the probability distribution information is based on the mixture parameters. In some examples, mixture density network 820 generates a mixing coefficient, where the probability distribution information is based on the mixing coefficient. Mixture density network 820 is an example of, or includes aspects of, the corresponding element described with reference to FIG. 9.

According to some aspects, classification network 825 decodes the encoded data to obtain threshold outage information, where the outage forecasting information is based on the threshold outage information.

Forecasting component 835 generates outage forecasting information for the computer network based on the probability distribution information. For example, forecasting component 835 may generate the outage forecasting information as described with reference to FIG. 2. Forecasting component 835 is an example of, or includes aspects of, the corresponding element described with reference to FIG. 7.

Change attribution component 840 may calculate causal graph 850 and vote-veto scores 855 based on deployment data 845, the time series data, and the outage forecasting information. For example, change attribution component 840 may calculate causal graph 850 and vote-veto scores 855 as described with reference to FIG. 4. Change attribution component 840 is an example of, or includes aspects of, the corresponding element described with reference to FIG. 7.

FIG. 9 shows an example of a mixture density network according to aspects of the present disclosure. The example shown includes encoded data 900, mixture density network 905, and probability distribution information 920.

Mixture density network 905 is an example of, or includes aspects of, the corresponding element described with reference to FIG. 8. In one aspect, mixture density network 905 includes hidden layers 910 and mixture parameters 915.

Referring to FIG. 9, mixture density network 905 receives encoded data 900, and using hidden layers 910, generates mixture parameters 915 and a mixture coefficient. For example, mixture density network may generate mixture parameters 915 and the mixture coefficient as described with reference to FIG. 3. Mixture density network 905 outputs probability distribution information 920. For example, mixture density network 905 may output probability distribution information 920 as described with reference to FIGS. 2 and 3. Probability distribution information 920 is an example of, or includes aspects of, the corresponding element described with reference to FIG. 5.

### Training

A method for outage forecasting is described. One or more aspects of the method include receiving training data including time series data for a service metric of a computer network and outage data for the computer network; generating probability distribution information for the service metric based on the time series data using a machine learning model; generating threshold outage information based on the time series data using the machine learning model; and updating parameters of the machine learning model based on the probability distribution information, the threshold outage information, and the outage data.

Some examples of the method further include encoding the time series data using a recurrent neural network of the machine learning model to obtain encoded data. Some examples further include decoding the encoded data using a mixture density network of the machine learning model to obtain mixture parameters for a plurality of distributions, wherein the probability distribution information is based on the mixture parameters. Some examples of the method further include decoding the encoded data using a classification network to obtain the threshold outage information.

Some examples of the method further include computing a distribution loss based on the probability distribution information and the outage data, wherein the parameters of the machine learning model are updated based on the distribution loss. Some examples of the method further include generating outage label data based on the outage data. Some examples of the method further include computing a binary cross-entropy loss based on the threshold outage information and the outage label data, wherein the parameters of the machine learning model are updated based on the binary cross-entropy loss. Some examples of the method further include computing an extreme value loss based on the threshold outage information and the outage label data, wherein the parameters of the machine learning model are updated based on the extreme value loss.

FIG. 10 shows an example of training a machine learning model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 10, a training component of a machine learning apparatus as described with reference to FIG. 7 may train a machine learning model of the machine learning apparatus to learn to generate probability distributions of service metrics that may be used to predict outages in the services based on an outage-likelihood probability threshold that may be arbitrarily determined by a user or by the machine learning apparatus. By learning to generate probability distributions for the service metrics rather than binary values, the machine learning model avoids a requirement that it be retrained whenever the outage-likelihood probability threshold is adjusted.

At operation 1005, the system receives training data including time series data for a service metric of a computer network and outage data for the computer network. In some cases, the operations of this step refer to, or may be performed by, a training component as described with reference to FIGS. 7 and 8. For example, the training component may receive time series data from a data collection component of the machine learning apparatus and outage data from the computer network. The outage data may be used as ground truth data that identifies actual outages. In some aspects, the outage data may be retrieved from a database as described with reference to FIG. 6.

At operation 1010, the system generates probability distribution information for the service metric based on the time series data using a machine learning model. In some cases, the operations of this step refer to, or may be performed by, a machine learning model as described with reference to FIGS. 7 and 8. For example, the machine learning model may generate probability distribution information as described with reference to FIGS. 2 and 3.

At operation 1015, the system generates threshold outage information based on the time series data using the machine learning model. In some cases, the operations of this step refer to, or may be performed by, a machine learning model as described with reference to FIGS. 7 and 8. For example, the machine learning model may generate threshold outage information as described with reference to FIGS. 2 and 3.

At operation 1020, the system updates parameters of the machine learning model based on the probability distribution information, the threshold outage information, and the outage data. In some cases, the operations of this step refer to, or may be performed by, a training component as described with reference to FIGS. 7 and 8.

According to at least one aspect, the training component computes a distribution loss based on the computing a distribution loss based on the probability distribution information and the outage data, wherein the parameters of the machine learning model are updated based on the distribution loss. The term “loss function” refers to a function that impacts how a machine learning model is trained in a supervised learning model. Specifically, during each training iteration, the output of the model is compared to the known annotation information in the training data. The loss function provides a value for how close the predicted annotation data is to the actual annotation data. After computing the loss function, the parameters of the model are updated accordingly and a new set of predictions are made during the next iteration.

Supervised learning is one of three basic machine learning paradigms, alongside unsupervised learning and reinforcement learning. Supervised learning is a machine learning technique based on learning a function that maps an input to an output based on example input-output pairs. Supervised learning generates a function for predicting labeled data based on labeled training data consisting of a set of training examples. In some cases, each example is a pair consisting of an input object (typically a vector) and a desired output value (i.e., a single value, or an output vector). A supervised learning algorithm analyzes the training data and produces the inferred function, which can be used for mapping new examples. In some cases, the learning results in a function that correctly determines the class labels for unseen instances. In other words, the learning algorithm generalizes from the training data to unseen examples.

In at least one embodiment, the distribution loss is a mean negative log-likelihood loss of a service metric y given the mixture parameters μ(x) and σ(x) (see description of FIGS. 2 and 3). Formally,

$$arg min l ( θ ) = - \frac{1}{\vert ℝ \vert} {\sum }_{x , y ∈ ℝ} log p ( y \vert x ) \qquad ( 5 )$$

Here [symbol] corresponds to the realm of possibilities, and the training component minimizes [symbol] (e.g., using a form of gradient descent) to learn the correct parameters for a mixture density network of the machine learning model.

According to at least one aspect, the training component generates outage label data based on the outage data. For example, thresholds that characterize an extreme event might not be known at training time, and pre-labeled training data that characterizes extreme events may not be unavailable. Therefore, the training component may use quantile-based thresholds to generate ground truth labels based on the outage data. The outage label data may be used by the training component to train a classification network of the machine learning model in a supervised learning process.

According to at least one aspect, the training component computes a classification loss that is a binary cross-entropy loss based on the threshold outage information and the outage label data, wherein the parameters of the machine learning model are updated based on the binary cross-entropy loss. The binary cross-entropy loss may be computed according to:

$${𝕃}_{B C E} = - \frac{1}{N} {\sum }_{i = 1}^{N} {y}_{i} * log \hat{{y}_{i}} + ( 1 - {y}_{i} ) * log ( 1 - \hat{{y}_{i}} ) \qquad ( 6 )$$

where N is the size of the batch of training data, yᵢ∈{0,1} is the true value of the outage label data, and ŷᵢ is the value predicted by the classification component (e.g., the threshold outage information).

According to at least one aspect, the training component computes a classification loss that is an extreme value loss based on the threshold outage information and the outage label data, wherein the parameters of the machine learning model are updated based on the extreme value loss. The extreme value loss may be computed according to:

$${𝕃}_{E V L} = - \frac{1}{N} {\sum }_{i = 1}^{N} {β}_{0} * {[ 1 - \frac{{y}_{i}}{γ} ]}^{γ} \hat{{y}_{i}} log {y}_{i} + {β}_{1} * {[ 1 - \frac{1 - {y}_{i}}{γ} ]}^{γ} ( 1 - \hat{{y}_{i}} ) log ( 1 - {y}_{i} ) \qquad ( 7 )$$

where β₀ is the proportion of normal events in the batch and β₁ is the proportion of extreme events in the dataset. In at least one embodiment, γ is equal to or about 2.

Therefore, according to at least one aspect, the classification network of the machine learning model is trained to learn distributions of extreme or rare events.

According to one aspect, the training component jointly trains the mixture density network and the classification network of the machine learning model using a common feature space. The mixture density network may learn to generate probability threshold information for service metrics of a computer network based on the distribution loss, and the machine learning model is fine-tuned using the classification loss to accurately predict extreme or rare events such that probability distribution information generated by the machine learning model includes accurate probability distribution tails.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method for outage forecasting, comprising:
receiving, by a machine learning model, time series data for a service metric of a computer network;
generating, by the machine learning model, probability distribution information for the service metric based on the time series data, wherein the machine learning model is trained using a distribution loss based on a distribution output of the machine learning model and a classification loss based on a classification output of the machine learning model; and
generating, by a forecasting component, outage forecasting information for the computer network based on the probability distribution information.

2. The method of claim 1, further comprising:
identifying, by a data collection component, a plurality of service metrics;
computing, by the data collection component, correlation information for the plurality of service metrics; and
filtering, by the data collection component, the plurality of service metrics based on the correlation information to obtain the service metric.

3. The method of claim 1, further comprising:
identifying, by a data collection component, a plurality of service metrics;
identifying, by the data collection component, one or more benchmark indicators; and
selecting, by the data collection component, the service metric from the plurality of service metrics based on the one or more benchmark indicators.

4. The method of claim 1, further comprising:
collecting, by a data collection component, data for the service metric for a plurality of instances; and
computing, by the data collection component, an aggregate value for the service metric over the plurality of instances at each of a plurality of time steps, wherein the time series data is based on the aggregate value.

5. The method of claim 1, further comprising:
encoding the time series data using a recurrent neural network to obtain encoded data; and
decoding the encoded data using a mixture density network to obtain mixture parameters for a plurality of distributions, wherein the probability distribution information is based on the mixture parameters.

6. The method of claim 5, further comprising:
generating a mixing coefficient using the mixture density network, wherein the probability distribution information is based on the mixing coefficient.

7. The method of claim 5, further comprising:
decoding the encoded data using a classification network to obtain threshold outage information, wherein the outage forecasting information is based on the threshold outage information.

8. The method of claim 1, further comprising:
generating, by a change attribution component, a causal graph based on the time series data for the service metric and deployment data related to the service metric; and
aggregating, by the change attribution component, causality information for a service based on the causal graph, wherein the outage forecasting information is based on the aggregated causality information.

9. The method of claim 8, further comprising:
filtering, by the change attribution component, a set of service changes corresponding to the deployment data based on the aggregated causality information.

10. The method of claim 1, further comprising:
determining, by the forecasting component, that a likelihood of an outage in the computer network exceeds a threshold based on the probability distribution information; and
transmitting, by the forecasting component, an alert based on the determination.

11. A method for training a machine learning model, comprising:
receiving, by a training component, training data including time series data for a service metric of a computer network and outage data for the computer network;
generating, by a machine learning model, probability distribution information for the service metric based on the time series data;
generating, by the machine learning model, threshold outage information based on the time series data; and
training, by the training component, parameters of the machine learning model based on the probability distribution information, the threshold outage information, and the outage data.

12. The method of claim 11, further comprising:
encoding, by a recurrent neural network of the machine learning model, the time series data to obtain encoded data; and
decoding, by a mixture density network of the machine learning model, the encoded data to obtain mixture parameters for a plurality of distributions, wherein the probability distribution information is based on the mixture parameters.

13. The method of claim 11, further comprising:
computing, by the training component, a distribution loss based on the probability distribution information and the outage data, wherein the parameters of the machine learning model are updated based on the distribution loss.

14. The method of claim 11, further comprising:
computing, by the training component, a binary cross-entropy loss based on the threshold outage information and the outage label data, wherein the parameters of the machine learning model are updated based on the binary cross-entropy loss.

15. The method of claim 11, further comprising:
computing, by the training component, an extreme value loss based on the threshold outage information and the outage label data, wherein the parameters of the machine learning model are updated based on the extreme value loss.

16. An apparatus for outage forecasting, comprising:
a machine learning model configured to generate probability distribution information for a service metric of a computer network based on time series data, wherein the machine learning model is trained using a distribution loss based on a distribution output of the machine learning model and a classification loss based on a classification output of the machine learning model; and
a forecasting component configured to generate outage forecasting information for the computer network based on the probability distribution information.

17. The apparatus of claim 16, further comprising:
a training component configured to update parameters of the machine learning model.

18. The apparatus of claim 16, further comprising:
a memory; and
a processor configured to cause the machine learning model and the forecasting component to operate based on instructions stored in the memory.

19. The apparatus of claim 16, further comprising:
a data collection component configured to collect the time series data for the service metric.

20. The apparatus of claim 16, further comprising:
a change attribution component configured to filter a set of service changes corresponding to deployment data based on the probability distribution information.
